(19) United States
(12) Patent Application Publication
(10) Pub. No.: US 2012/0114036 A1
(43) Pub. Date: May 10, 2012

(54) Method and Apparatus for Multiview Video Coding

(75) Inventors: LAI MAN PO, Hong Kong (HK); Ka Man WONG, Hong Kong (HK); Kwok Wai CHEUNG, HONG KONG (HK); Ka Ho NG, Hong Kong (HK); Yu LIU, Hong Kong (HK)

(73) Assignee: Hong Kong Applied Science and Technology Research Institute Company Limited, Hong Kong (HK)

(21) Appl. No.: 12/943,021

(22) Filed: Nov. 10, 2010

(51) Int. Cl. H04N 7/12; H04N 13/00

(52) U.S. Cl. 375/240.12; 348/43; 348/E13.001

(57) ABSTRACT

The present invention relates to method and apparatus for multiview video coding. In particular, the present invention describes a disparity compensated prediction to exploit the inter-view correlation in multiview video coding by providing stretching, compression, and shearing (SCSH) disparity compensation to approximate the actual disparity effects in addition to the translational disparity. A sub-sampled block-matching disparity estimation technique is provided to implement the SCSH disparity compensation which makes use of the interpolated reference frames for subpixel motion and disparity estimation in conventional hybrid video coding structure.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to digital video coding, and more particularly, to multiview video coding (MVC).

### BACKGROUND

Three dimensional (3D) images and videos not only provide more information but also give audience better experience. User perception of depth and the associated sensation of reality provided by 3D videos have become increasingly attractive features in digital entertainment. This gives rises to an increasing demand for 3D solutions and drives the rapid development of image acquisition, video compression and video display technologies for 3D movies and 3DTV.

There are two popular types of 3D videos—stereo video and multiview video. Stereo video has two views, usually left and right, which emulate the stereoscopic vision of human to provide depth perception. Multiview video has two or more views with view angle chosen by user or automatic means. Various 3D display systems using different video display technologies are available to movie theaters and home entertainment market for 3D video display. Multiview video coding is a key technology to enable efficient coding, storage and transmission of such video data, as described in “Introduction to Multiview Video Coding,” ISO/IEC JTC 1/SC 29/WG 11 Doc. N9580, January 2008, Antalya, Turkey, which is hereby incorporated by reference in its entirety.

In MVC, the relative positions between cameras are usually known. Computer vision approaches may be used to perform 3D shape reconstruction to predict the content of one view from other views. The process involves edge detection, depth estimation, transformation parameter estimation, 3D rendering and other related operations. It is too computation heavy to adopt these techniques in video coding applications. Even the 3D information in a scene is available, specific 3D-accelerated computer graphics hardware is required to perform high quality 3D rendering to obtain the desired view in real time. For instance, a real-time 3D shape reconstruction system constructed by a cluster with 30 PCs is reported in T. Matsuyama, W. Xiaojun, T. Takai, and T. Wada, “Real-time dynamic 3-D object shape reconstruction and high-fidelity texture mapping for 3-D video,” IEEE Trans. Circuits Syst. Video Technol., vol. 14, no. 3, pp. 357-369, March 2004, which is hereby incorporated by reference. Thus, it is impractical for real-time digital video applications for handheld devices.

Both MPEG-2 as described by ITU-T_and_ISO/IEC_JTC-1, “Generic coding of moving pictures and associated audio information—Part 2: Video,” ITU-T Recommendation H.262—ISO/IEC 13818-2 (MPEG-2), 1995, which is hereby incorporated by reference, and H.264/AVC as described by T. Wiegand, G. J. Sullivan, G. Bjøntegaard, and A. Luthra, “Overview of the H.264/AVC video coding standard,” IEEE Trans. Circuits Syst. Video Technol., vol. 13, no. 7, pp. 560-576, July 2003, which is hereby incorporated by reference, can support up to two views by interleaving the two views temporarily or spatially but the coding efficiency is not very good. To exploit the correlations among different views, MVC extension of H.264/AVC from the Joint Video Team (JVT) is developed. It extends the current framework of H.264/AVC instead of using the computer vision (CV) paradigm. Block-based disparity compensated prediction (DCP) is adopted for inter-view prediction due to its similarity to motion compensated prediction (MCP). Many prediction techniques such as multiple reference frames (MRF) as described in T. Wiegand, X. Zhang, and B. Girod, “Long-term memory motion compensated prediction,” IEEE Trans. Circuits Syst. Video Technol., vol. 9, no. 1, pp. 70-84, February 1999 which is incorporated by reference, variable block size (VBS) as described in G. J. Sullivan and R. L. Baker, “Rate-distortion optimized motion compensation for video compression using fixed or variable size blocks,” in Proceedings of Global Telecommunications Conference, Phoenix, Ariz., USA, 1991, pp. 85-90 which is hereby incorporated by reference, sub-pixel MCP as described in T. Wedi and H. G. Musmann, “Motion-and Aliasing-Compensated Prediction for Hybrid Video Coding”, IEEE Trans. Circuits Syst. Video Technol., vol. 13, no. 7, pp. 577-586, July 2003 which is hereby incorporated by reference, hierarchical prediction structure as described by H. Schwarz, D. Marpe, and T. Wiegand, “Analysis of hierarchical B pictures and MCTF,” in IEEE Int. Conf. Multimedia and Expo (ICME 2006), pp. 1929-1932, Toronto, ON, Canada, July 2006 which is hereby incorporated by reference, and fast motion estimation algorithms are already available for MCP. The differences between views are considered as the camera is panning from the one position to another one. The prediction error is encoded by residue coding. The major contribution of MVC extension is the Group Of Picture (GOP) structure that provides efficient DCP as described in P. Merkle, A. Smolic, K. Muller, and T. Wiegand, “Efficient Prediction Structures for Multiview Video Coding,” IEEE Trans. Circuits Syst. Video Technol., vol. 17, no. 11, pp. 1461-1473, November 2007 and M. Kitahara, H. Kimata, S. Shimizu, K. Kamikura, Y. Yashima, K. Yamamoto, T. Yendo, T. Fujii, and M. Tanimoto, “Multi-view video coding using view interpolation and reference picture selection,” presented at the IEEE Int. Conf. Multimedia and Exposition (ICME 2006), pp. 97-100, Toronto, ON, Canada, July 2006 which are hereby incorporated by reference. The rate-distortion (RD) improvement is comparable to simulcast as described in Y. J. Jeon, J. Lim, and B. M. Jeon, “Report of MVC performance under stereo condition,” Doc. JVT-AE016, Joint Video Team, London, UK, June 2009 which is hereby incorporated by reference. Some methods within the standard are also proposed in T. Frajka, and K. Zeger, “Residual image coding for stereo image compression,” Optical Engineering, vol. 42, no. 1, pp. 182-189, January 2003, J. Kim, Y. Kim, K. Sohn, “Stereoscopic video coding and disparity estimation for low bitrate applications based on MPEG-4 multiple auxiliary components,” Signal Processing: Image Communication, vol. 23, issue 6, pp. 405-416, July 2008, and X. M. Li, D. B. Zhao, X. Y. Ji, Q. Wang, and W. Gao, “A fast inter frame prediction algorithm for multiview video coding,” in Proc. IEEE Int. Conf. Image Process. (ICIP), vol. 3. September 2007, pp. 417-420 which are hereby incorporated by reference. They usually analyze the inter-view correlation for the disparity estimation such that the disparity vector is matched with the actual disparity.

The conventional block based inter-view prediction approach is pure translational and does not adopt the disparity effect between views. If a candidate block that matches the deformation effect between views is available, the prediction accuracy and the coding efficiency should be improved. Mesh based methods as described in R. S. Wang and Y. Wang, “Multiview Video Sequence Analysis, Compression, and Virtual Viewpoint Synthesis,” IEEE Trans. Circuits Syst. Video Technol., vol. 10, no. 3, pp. 397-410, April 2000 and S. R. Han, T. Yamasaki, K. Aizawa, “Time-Varying Mesh Compression Using an Extended Block Matching Algorithm,” IEEE Trans. Circuits Syst. Video Technol., vol. 17, no. 11, pp. 1506-1518, November 2007., which are hereby incorporated by reference, were proposed for transforming a view to another. The prediction accuracy is improved by adopting the deformations formed by disparity effects but the complexity of handling the mesh is still high. Instead of generating a mesh, it is possible to approximate the deformations by providing prediction blocks or frames with various deformations. Among the deformation effects, Stretching, Compression and Shearing (SCSH) effects are the most common deformation between views, especially while the cameras are horizontally or vertically positioned. This approach was not very attractive in the past since it usually requires interpolation operation to obtain the deformed block or frames. Recently, a subsampled block matching technique as described in L. M. Po, K. M. Wong, K. W. Cheung, and K. H. Ng, “Subsampled Block-Matching for Zoom Motion Compensated Prediction”, accepted for publication in IEEE Trans. Circuits Syst. Video Technol., which is hereby incorporated by reference, demonstrated a good approximation of zoom motion compensated prediction in a low complexity way. By further generalizing the subsampled block matching idea, various types of deformations can be achieved by specially designed subsampling grid. In this work, SCSH by subsampled block matching is proposed for inter-view prediction for MVC.

Stereovision

It is one of the ways how human can perceives a 3D space with his left and right eyes. There are a number of methods to provide the left and right images to the left and right eyes respectively. Stereovision is now being widely adopted in film production and the applications in digital entertainment are becoming more popular.

In stereovision system, two image capture devices are displaced by a few centimeters from each other. As the viewing angle to an object from each image capture device is different, views on the left will be different from views on the right. 3D reconstruction depends on matching the parts corresponding to the same object in the scene between the left and right views and estimating the depth of the correspondent points.

FIG. 1 shows a simple disparity model commonly used in stereo computer vision, where P 110 is the object to be observed. C_{L} 120 and C_{R} 123 are the centers of projection. t_{c} is the distance between eyes and f is the common focal length. P_{L} 130 and P_{R} 133 are the projected locations. The difference between the displacement x_{L} of the projected location P_{L} 130 and the displacement x_{R} of the projected location P_{R} 133 is known as disparity. The depth Z can be estimated by the disparity.

For stereo image and video compression, providing predictions that matched the deformation can improve the coding efficiency. 3D reconstruction is not necessary if an arbitrary view rendering is not required. As stereovision has a fixed relationship between cameras, the property should be valid for all stereo images and videos. From the disparity model shown in FIG. 1, the following properties are observed:
(i) The disparity is small for distant object.
(ii) The disparity is constant if the depth is constant.
(iii) The disparity is inversely proportional with depth.

From (i) and (ii), the difference between left and right views for distant objects and flat objects, such as a plane in the scene, with motion parallel to the viewing plane should be purely translational. Conventional block matching techniques can give a very good prediction. However, point (iii) implies that different levels of deformation will happen to the same 3D objects between different views depending on the distance from the cameras. More details on the limitations of existing video coding standard in handling stereo and multiview contents will be discussed in the following:

Stereo and Multiview Video Coding

The stereo image and video coding methods used in the recent consumer stereo digital cameras available in the market are not efficient. H.264/AVC has MVC extension supporting large number of views with arbitrary camera positions. Two new profiles—Stereo High and Multiview High—are available in the MVC extension. Stereo video is supported by using two views assuming two horizontally positioned cameras. Although some new coding tools were proposed to JVT in the development stage, no specific new coding tool was adopted. The major difference between MVC encoder and H.264/AVC encoder is the coding structure. Hierarchical coding is used to form an efficient prediction structure for stereo and multiview video coding as shown in FIGS. 2 and 3.

FIG. 2 shows a prediction structure of stereo video coding. The solid arrows indicate conventional inter frame prediction. The double dotted arrows indicate inter-view prediction. The dotted arrows are optional inter-view prediction.

FIG. 3 shows a prediction structure of multiview video coding with 6 views. View 0 310 is the base view. Views 2 320, 4 360, 5 340 are P views, view 1 350, 3 330 are B views.

In stereo case, I frame is available only in the left view. There is no I frames in right view. In MVC case, all frames in B view can be predicted by bi-prediction such that the bit rate can be further reduced. Inter-view prediction is used to remove the redundancies among different views. It can be achieved by rearranging the encoding order such that the frames from different view can be referenced efficiently.

FIG. 4 shows an example of prediction order to achieve the prediction structure shown in FIG. 2.

Block Matching Based Motion Compensated Prediction

Block Matching based Motion-Compensated Prediction (MCP) is the core technique contributing to the high coding efficiency of the modern video coding schemes. In MCP, a frame is divided into non-overlapping blocks. Motion estimation is applied to find a prediction for each block based on the data in previously encoded frame. A residue block is created by subtracting the prediction from the current block. Only the residue block and the data (motion vector) required for reproducing the prediction are encoded. The compression performance highly depends on the prediction accuracy. In H.264/AVC, several MCP tools are adopted to improve the prediction accuracy. Sub-pixel MCP enables more accurate motion vector up to ¼ pixel precision. With the specially designed wiener filter, the aliasing effect is small such that the coding efficiency can be significantly improved. FIG. 5 shows a block-matching motion estimation with ½-pixel motion vector accuracy to illustrate the basic idea of sub-pixel MCP. The block for matching is obtained from the interpolated frame. With MRF technique, MCP can reference a frame not only the previously decoded frame, but also a frame from a longer period of time that solved the problem of temporary occlusion. FIG. 6 shows an example of temporary occlusion and MCP with MRF. For example, for the current frame 640, the highlighted blocks to be matched 641 and 642 cannot make the best matches in the reference frame 630 at the immediately preceding time instance. As objects in the scene move and change at different time instances, temporary occlusion may occur. With the availability of multiple reference frames at different time instances, the likelihood of finding the best matches greatly increases.

Block Matching Disparity Compensated Prediction

In stereo and multiview video coding, the frames capture the same scene at the same time with different camera locations. The correlation between views is very similar to single view video sequence with motion parallax effect. The difference between views depends on disparity effects. If the disparity information can be exploited like motions in MCP, the coding efficiency of the alternative views can be improved significantly. H.264/AVC MVC extension handles disparity compensated prediction (DCP) using the same set of coding tools for single view encoding. The reference frame from other views, instead of previous frames from the same view, is used in DCP. Practically, there is no additional parameter in the encoded bit-stream. The reference frame parameter indicates the inter-view frame and the motion vector parameter holds the disparity vector.

Limitation of Block-Matching Based Disparity Compensated Prediction

The conventional disparity compensated prediction is based on block-matching assuming a translation motion model in which the disparity vectors of all pixels in a block are the same. However, the disparity model is pixel based instead of block based. Each pixel has different disparity vector, as the depth of every pixel in the frame can be different. To compare the difference of translation model and the pixel disparity model, two stereo image pairs are shown in FIG. 7 and FIG. 8. In FIG. 7, the depth information of two objects can be visualized by the disparity effect and the 2D shape is exactly the same. In this case, the depth information within the object is lost and the scene becomes two layers of flat objects. In FIG. 8, the shapes of the objects in two views have small differences and the depth within the objects remains. A real world example provided in FIG. 9 is also considered. From FIG. 10, a zoom-in version of part of FIG. 9, vertical objects (e.g. walls 1010 and 1020) appear to be horizontally stretched or compressed between views. From FIG. 11, the horizontal objects (e.g. ceiling 1110 and 1120) appear to be sheared between views. Based on this observation, it is possible to combine block-based approach with SCSH effects to provide the effect of pixel based disparity model.

Although SCSH disparity compensated prediction can be achieved intuitively by a simple frame based approach as shown in FIG. 12, the complexity and the memory requirement of generating these SCSH frames make it impractical. For matching the current frame 1210 with the inter-view reference frame 1220, the inter-view reference frame 1220 is compressed to various degrees into compressed frames 1231 and stretched to various degrees into stretched frames 1232. In addition, the inter-view reference frame 1220 is also sheared left to various degrees into left-sheared frames 1241 and sheared right to various degrees into right-sheared frames 1242. The compressed frames 1231, stretched frames 1232, left-sheared frames 1241 and right-sheared frames 1242, so-called “SCSH frames”, are used to be matched with the current frame 1210 for motion prediction. For example, the solid arrows refer to the matching between the current frame 1210 and these SCSH frames. Generating and matching these SCSH frames with the current frame 1210 requires a lot of memory and computations. Therefore, there is a need for a more practical approach which is practically implementable.

### SUMMARY OF THE INVENTION

A first aspect of the present invention is to provide a more practical approach for SCSH disparity compensated prediction which lowers the requirements on memory and has a lower computational complexity.

A second aspect of the present invention is to model stretching, compression and shearing for block matching with subsampling on the interpolated reference frames for interview prediction. With the modeling of the deformation such as stretching, compression and shearing taken into consideration, the disparity compensated prediction can obtain more accurate disparity model which improves compression efficiency of multiview video coding. In other words, the present invention increases the prediction accuracy of disparity compensated prediction for multiview video coding.

A further aspect of the present invention is to model disparity effects such that deformation such as stretching, compression and shearing are also considered without using higher order motion models that developed for single view video, such as affine, perspective, polynomial, elastic. All these require parameter estimation which is too complex to be practical. Although a mesh based method is proposed to adopt disparity effects by matching the corresponding points between views, this also requires parameter. Therefore, the present invention lowers the complexity for building motion or disparity models by avoiding this sort of parameter estimation.

Since the SCSH disparity estimation is performed by block matching process on the interpolated frame of the subpixel disparity estimation, no additional memory is required. In addition, the present invention can be easily deployed in existing video coding standards such as H.264/AVC and its MVC extension, or adopted in future video coding standards such as H.265 or HVC.

The present invention receives a video signal representing a plurality of multiview video frames, the number of multiview video frames ranging from 1 to N, where N is a whole number greater than or equal to 2; selects one multiview video frame from the N multiview video frames as a reference video frame; interpolates the reference video frame by a scale of M into an interpolated reference video frame such that the number of pixels of the reference video frame is increased by M times with each of the pixels of the reference video frame generating M by M subpixels; and generates a subsampled reference block by sampling the interpolated reference video frame such that a deformation is introduced to the subsampled reference block.

The present invention further divides each of the multiview video frames into a plurality of blocks, each block having a size of A by B such that said one or more processors process data in form of block by block instead of frame by frame, where A and B are whole numbers respectively.

The deformation has a horizontal effect by adjusting a horizontal sampling rate when sampling the interpolated reference video frame. The deformation has a shearing effect by applying a shear factor when sampling the interpolated reference video frame. The horizontal effect is a compression when said horizontal sampling rate is selected to be higher than a vertical sampling rate for sampling the interpolated reference video frame. Alternatively, the horizontal effect is a stretching when said horizontal sampling rate is selected to be lower than a vertical sampling rate for sampling the interpolated reference video frame.

The present invention further provide one or more additional reference frames such that each of the additional reference frames are interpolated and sampled without deformation. The present invention further generates a pixel location for chroma component corresponding to the deformation. Furthermore, one or more zooming effects are applied to said subsampled reference block by using various sampling rates. The present invention further performs disparity vector search among one or more reference frames interpolated and sampled with deformation and a plurality of additional reference frames interpolated and sampled without deformation.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 shows a simple disparity model commonly used in stereo computer vision.

FIG. 2 shows a prediction structure of stereo video coding.

FIG. 3 shows a prediction structure of multiview video coding with 6 views.

FIG. 4 shows an example of prediction order to achieve the prediction structure shown in FIG. 2.

FIG. 5 shows a block-matching motion estimation with ½-pixel motion vector accuracy.

FIG. 6 shows an example of temporary occlusion and MCP with MRF.

FIG. 7 shows a stereo image pair where the shapes of the objects remain unchanged in different views.

FIG. 8 shows a stereo image pair where the objects have their shapes varied in different views.

FIG. 10 shows an example of real world stereo image pair, which is a magnification of the wall in FIG. 9.

FIG. 11 shows an example of real world stereo image pair, which is a magnification of the ceiling in FIG. 10.

FIG. 12 illustrates a simple frame based approach for SCSH disparity compensated prediction.

FIG. 13 shows an example of obtaining a 4/3-times zoomed block from the interpolated frame.

FIG. 14 shows a subsampling grid of BTZMCP.

FIG. 15 shows a block-matching on a reference frame of zoom factor=4/3.

FIG. 16 shows a block-matching on a reference frame of compression factor of 3/4.

FIG. 17 shows a block-matching on a reference frame of stretching factor of 5/4.

FIG. 18 shows a block-matching on a reference frame of horizontal shearing factor of 1.

FIG. 19 shows a block-matching on a reference frame of horizontal shearing factor of −1.

FIG. 20a shows a block-matching on a reference frame of horizontal shearing factor of 0.5.

FIG. 20b shows a block-matching on a reference frame of horizontal shearing factor of 1 and a compression factor of 3/4.

FIG. 20c shows a block-matching on a reference frame of horizontal shearing factor of −1 and a stretching factor of 5/4.

FIG. 21 shows a generic device with the capability of multiview video coding in accordance with some embodiments.

FIG. 22 shows a flowchart for an embodiment for multiview video coding in the present invention.

FIG. 23 shows a block diagram illustrating an exemplary embodiment of how the present invention is used in an exemplary encoder system.

FIG. 24 shows a block diagram illustrating an exemplary embodiment of how the present invention is used in an exemplary decoder system

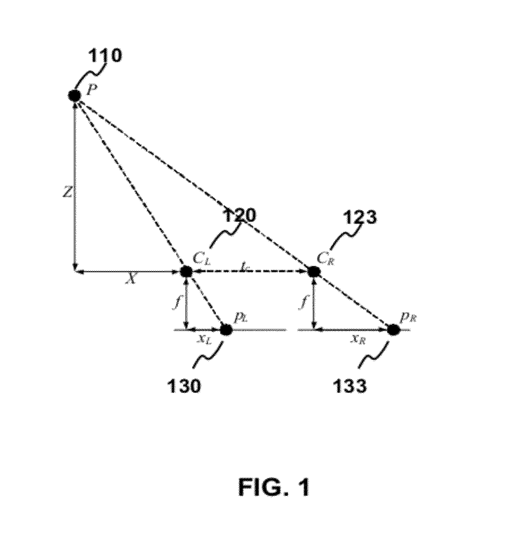

### DETAILED DESCRIPTION OF THE INVENTION

### Subsampled Block Matching for Motion Compensated Prediction (MCP)

Although SCSH effects can be achieved by applying affine transforms or by providing reference frames with SCSH effects, the computational complexity and the memory requirement are significant as discussed above. Subsampled block-matching is used to efficiently provide zoomed reference frames for zoom motion compensated prediction. It subsamples the interpolated frame, which is already available for sub-pixel MCP, with various subsampling rates to obtain block with different zoom effects. It does not require additional operation to obtain a zoomed block nor additional memory space for storing zoomed frames. Given the availability of the zoomed block, the motion model extended to translation and zoom such that Block-matching Translation and Zoom MCP (BTZMCP) performed. The MCP can be generalized to include zoom reference frames \tilde{f}ₘ(s/a), aε [symbol] where fₘ(s) is the interpolated version of the previously decoded frame \tilde{F}ₘ(s) for sub-pixel MCP. The zoom factor a is determined as an additional parameter in the motion estimation process as:

$$( a , m , {v}_{i , n} ) = arg {min}_{a , m , v} {BDM}_{{B}_{i , n}} ( {F}_{n} ( s ) , {\tilde{f}}_{m} ( s / a - v ) ) \qquad ( 1 )$$

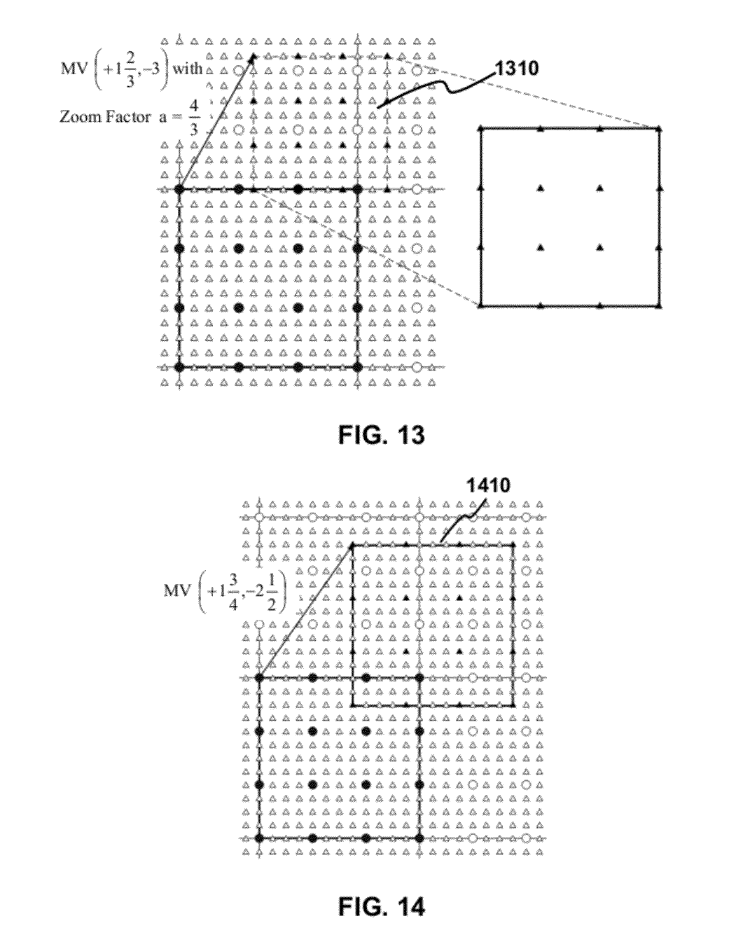

For a>1, \tilde{f}ₘ(s/a) is a zoom-in reference frame. For a<1, \tilde{f}ₘ(s/a) is a zoom-out reference frame. In block-matching MCP, since each block B_{i,n} may has its own zoom factor a, a single frame may be composed of both zoom-in and zoom-out blocks of different zoom factors. Thus, this BTZMCP as described by the equation (1) can better model the real world situation in which the projection of different regions or objects of a scene onto the imaging plane may exhibit zoom effects of various degrees. FIG. 13 shows an example of obtaining a 4/3-times zoomed block 1310 from the interpolated frame.

Different subsampling patterns are used to achieve more variations. For quarter pixel MCP, the subsampling grid of BTZMCP can be obtained by the following transformation:

$$[ {x}^{′} {y}^{′} 1 ] = [ \begin{matrix}4 & 0 & u \\ 0 & 4 & v \\ 0 & 0 & 1\end{matrix} ] [ \begin{matrix}x \\ y \\ 1\end{matrix} ] \qquad ( 2 )$$

where (x, y) and (x′, y′) are the relative coordinates of the pixels of in the current block and reference block, respectively. (u, v) is the translational motion vector in the interpolated frame. The subsampling grid 1410 is shown in FIG. 14 and there is no zooming effect for this subsampling grid 1410. The block given by the subsampling grid is known as a subsampled block, in other words, the subsampled block is formed by the subpixels selected by the subsampling grid.

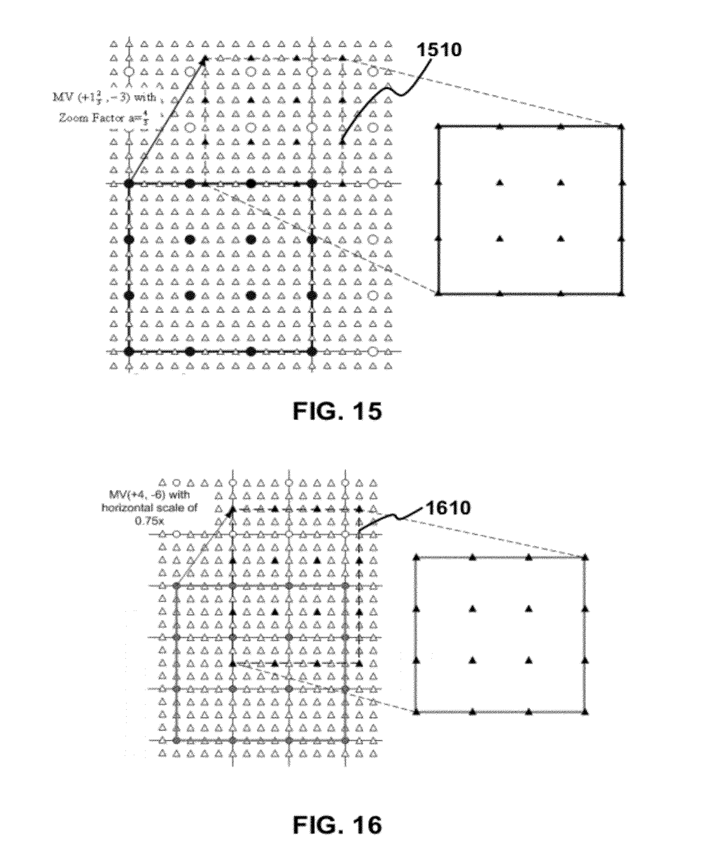

To provide zoomed candidate block, the subsampling factor is introduced into the transform matrix so that subsampling grid of BTZMCP becomes:

$$[ {x}^{′} {y}^{′} 1 ] = [ \begin{matrix}s & 0 & u \\ 0 & s & v \\ 0 & 0 & 1\end{matrix} ] [ \begin{matrix}x \\ y \\ 1\end{matrix} ] \qquad ( 3 )$$

where s=(1, 2, . . . , M) is the subsampling rate associated with the zoom levels and the possible zoom scale are 4/s. With s=3, the zoomed block 1510 as shown in FIG. 15 can be obtained. Based on above transformations, subsampling grid for SCSH can be defined.

SCSH by Subsampled Block Matching

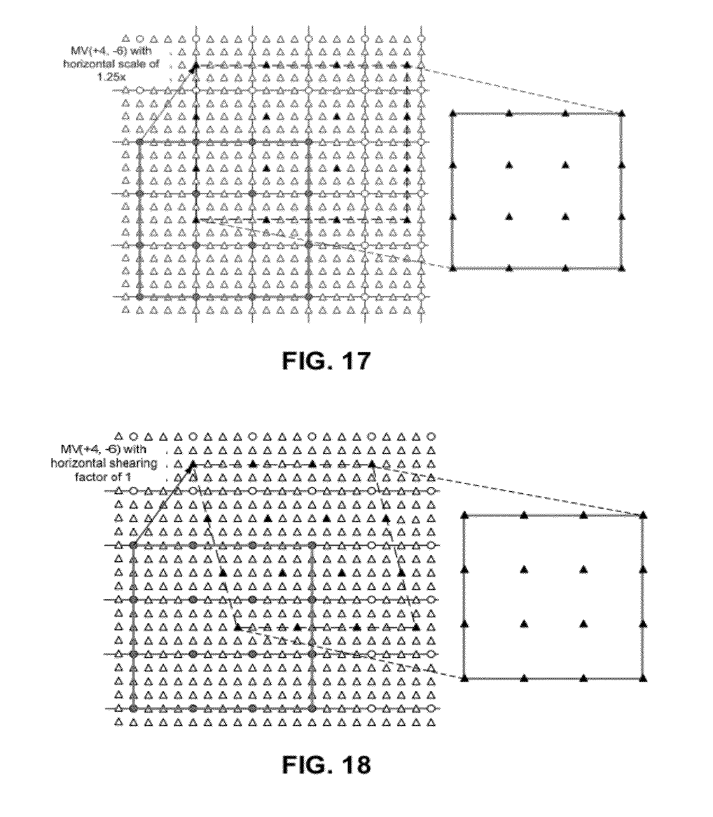

SCSH by subsampled block matching is proposed for inter-view prediction especially stereo video coding. Unlike in BTZMCP, in which the subsampling rates are the same in both row and column directions, the subsampling grids of SCSH are asymmetric. Stretching and compression (SC) is different from zoom that only the horizontal sub-sampling rate is changed. The subsampling grid of SC is defined as:

$$[ {x}^{′} {y}^{′} 1 ] = [ \begin{matrix}sc & 0 & u \\ 0 & 4 & v \\ 0 & 0 & 1\end{matrix} ] [ \begin{matrix}x \\ y \\ 1\end{matrix} ] \qquad ( 4 )$$

where sc=(1, 2, . . . , M). The subsampling grids for compression and for stretching are illustrated in FIG. 16 and FIG. 17 respectively. Stretch and compression can be achieved without performing additional interpolation. For the subsampling grid 1610, the horizontal sampling rate is not the same as the vertical sampling rate. The horizontal sampling rate is sampling at every 3 subpixels while the vertical sampling rate is sampling at every 4 subpixels. This gives rise to a horizontal scale of 0.75x.

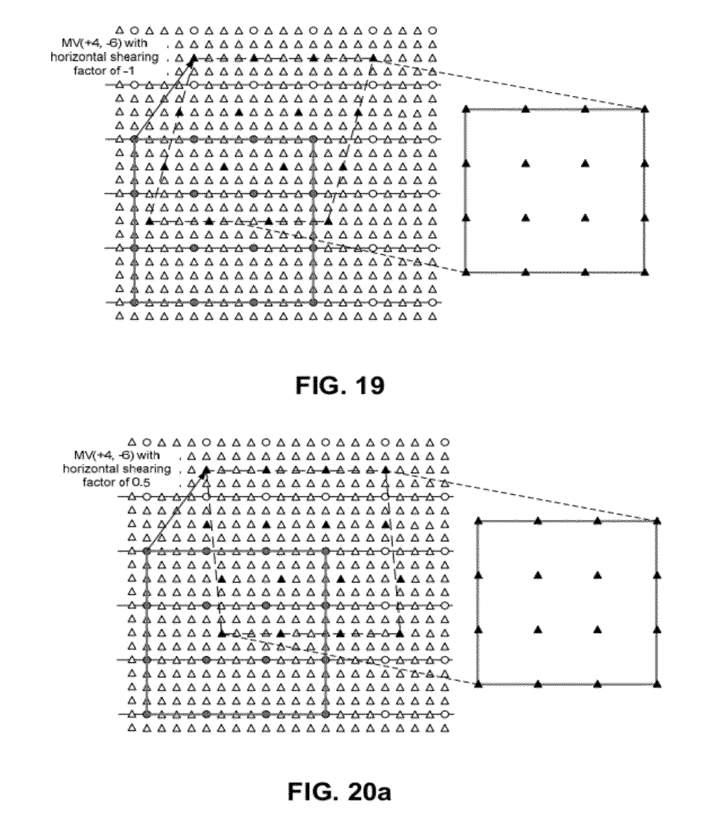

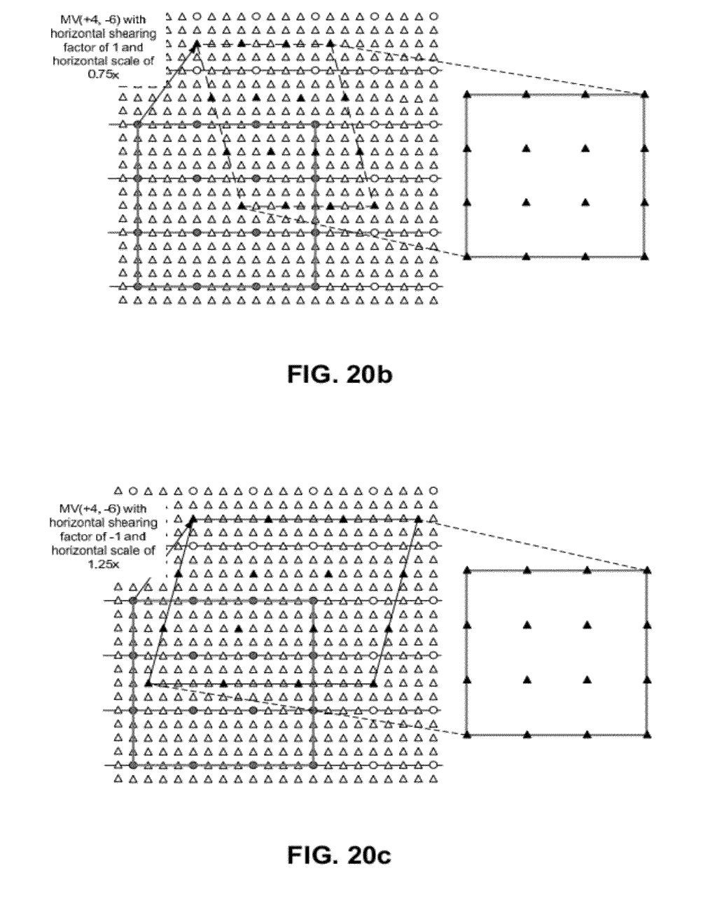

Furthermore, shearing (SH) can also be obtained by the following transform matrix:

$$[ {x}^{′} {y}^{′} 1 ] = [ \begin{matrix}4 & sh & u \\ 0 & 4 & v \\ 0 & 0 & 1\end{matrix} ] [ \begin{matrix}x \\ y \\ 1\end{matrix} ] \qquad ( 5 )$$

where sh=(−H, . . . , −1, 0, 1, . . . , H) is the shearing factor that shifts the x coordinate depending on y coordinate. Shearing factor can be negative or positive such that the shearing can be left or right. FIGS. 18 and 19 illustrates examples of subsampling grid of shearing. Finer shearing factors can also be used such as h=(−H/2, . . . , −½, 0, ½, . . . , H/2) and the fractional positions are truncated. FIG. 20a illustrates the subsampling grid of shearing factor of 0.5.

FIG. 20b illustrates the subsampling grid of shearing factor of 1 and compression of 3/4. FIG. 20c illustrates the subsampling grid of shearing factor of −1 and stretching of 5/4. The deformation being applied to the subsampling grid can be in various combinations of zooming, shearing, stretching and compression. In these exemplary embodiments, the deformation is a combination of shearing and compression as shown in FIG. 20b and a combination of shearing and stretching as shown in FIG. 20c.

In one embodiment, the transform is applied on subsampling grid instead of the reference frames. Thus, there will be no transformation and interpolation operations involved if the resulting grid is hard coded in the codec. The overhead involved are: (i) the bits for indicating the SCSH parameter, which can be integrated with the reference frame number like BTZMCP, and (ii) a flag to indicate SCSH is on or off in the macroblock, which can be integrated with the block mode number. In addition, if the camera position is up and down instead of left and right, the SCSH effect should be vertical instead of horizontal.

In one embodiment, the reference frame number is offset by 15. If it is desired to have 12 candidates for SCSH frames, the reference frame 16 to 27 are dedicated to be SCSH frames. To determine which SCSH parameter is used and thus which subsampling grid is adopted, the following lookup table is used:

TABLE I
Lookup table for SCSH parameters

| | 0- | | | | | | | | | | | | |
|---|---|---|---|---|---|---|---|---|---|---|---|---|---|
| | 15 | 16 | 17 | 18 | 19 | 20 | 21 | 22 | 23 | 24 | 25 | 26 | 27 |
| Reference | 0- | 0 | 0 | 0 | 0 | 0 | 0 | 0 | 0 | 0 | 0 | 0 | 0 |
| frame | 15 | | | | | | | | | | | | |
| number | | | | | | | | | | | | | |
| Horizontal | 4 | 3 | 5 | 2 | 6 | 4 | 4 | 4 | 4 | 3 | 3 | 5 | 5 |
| subsam- | | | | | | | | | | | | | |
| pling rate | | | | | | | | | | | | | |
| Shearing | 0 | 0 | 0 | 0 | 0 | 1 | −1 | 2 | −2 | 1 | −1 | 1 | −1 |
| factor | | | | | | | | | | | | | |

Alternate inter mode numbers are used to switch the SCSH effect on and off. For example, if inter mode number is 1, this indicates 16×16 mode without SCSH and the SCSH effect is switched off, encoding the video frames as original H.264/AVC. If inter mode number is 16, this indicates 16×16 mode with SCSH and the SCSH effect is switched on, encoding the video frames according to the lookup table for SCSH parameters as shown in Table I. To represent the SCSH effects, the pixel locations for Chroma components are recalculated. For the bitstream encoding, the reference frames numbers and mode number are included for bitstream encoding.

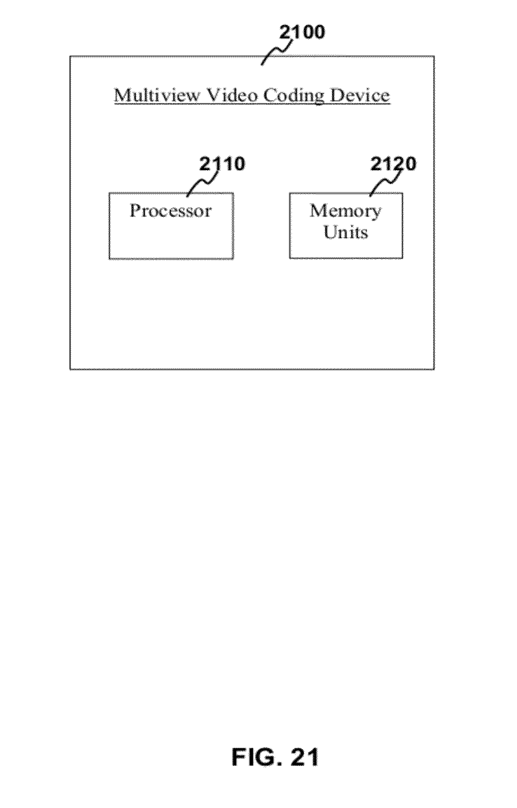

FIG. 21 shows a generic device with the capability of multiview video coding in accordance with some embodiments. The generic device 2100 has one or more processors 2110 which perform functions such as control and processing. The generic device 2100 further includes one or more memory units 2120 which store information such as one or more programs, instructions and data. The one or more processors 2110 are configured to implement the multiview video coding in accordance with the present invention as disclosed herewith.

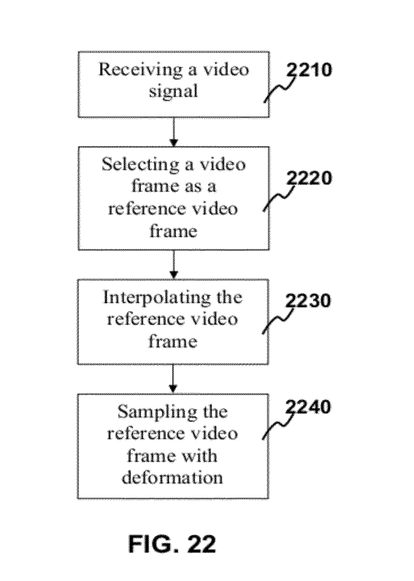

FIG. 22 shows a flowchart for an embodiment for multiview video coding in the present invention. A multiview video device receives a video signal which is a multiview video during a receiving process 2210. At each time instance of the multiview video, a number of multiview video frames are available representing various views for the same scene at this time instance. For example, if there are N views which are captured by N video cameras, there will be N multiview video frames at each time instance.

The multiview video device performs disparity vector search by selecting one or more multiview video frames as a reference video frame in a selecting process 2220. Furthermore, these multiview video frames are divided into blocks, for example 16×16 blocks, so that the disparity vector search is performed in form of a block matching among these multiview video frames.

A reference video frame is interpolated to generate an interpolated reference video frame through an interpolating process 2230. A pixel in the reference video frame is interpolated into a plurality of subpixels according to a scale M. For example, if the scale is 4, which is also known as quarter pixel MCP, then the pixel will be interpolated into 4×4 subpixels. In a sampling process 2240, the interpolated reference video frames are sampled into a plurality of subsampled reference blocks. This subsampled reference blocks is given a deformation. The provision of the deformation is implemented by transforms as mentioned above so that SCSH effects can be provided.

The horizontal effect of the deformation is in a form of compression or stretch and this is done by using different sampling rates along the horizontal and vertical directions. If the horizontal sampling rate is higher than the vertical one, there will be a compression along the horizontal direction. If the horizontal sampling rate is lower than the vertical one, there will be a stretch along the horizontal direction. For shearing, a shear factor is applied so that the subsampled reference block can be sheared left or right.

The multiview video coding can switch the SCSH effect on and off so that the subsampled reference block may or may not have any deformation. By varying the sampling rates, the multiview video coding provides different zooming effects to the subsampled reference block.

Analysis on SCSH for Inter-View Prediction

The inter-view prediction gain of SCSH by sub-sampled block matching will be presented via several experiments. Firstly, the direct improvement of SCSH will be compared to the conventional block based inter-view prediction approach. Secondly, the improvement of SCSH in commonly used MVC configuration is also provided to show the effect of SCSH in practical use.

Experiment Setup

SCSH is applied on large block modes (16×16, 16×8 and 8×16) of P frames only. In the experiments, four sequences ballroom, exit, vassar, and rena used in JVT for developing H.264 MVC extension will be used. The sequences are in VGA (640×480) resolution. Each sequence has many views and two consecutive views are taken as a stereo pair. The first 100 frames from each view will be used. The H.264/AVC coding tools like VBS and RDO are turned on. Search window is set at ±32 and exhaustive search is used within the search window. Left view is used as the base view and the right view is the alternate view predicted by inter-view prediction or inter prediction. Due to the special coding structure of MVC, P frames in right view use only inter-view prediction and B frames use only inter prediction. GOP structures without B frames and with 7 hierarchical B frames are tested. The average bitrate reduction and average PSNR improvement are calculated using Bjøntegaard's method.

Direct Improvement of SCSH Inter-View Prediction

To investigate the direct improvement, GOP structure IIII is used for base view and PPPP for the alternate view. Since the P frames only use inter-view prediction, performance of SCSH and conventional block matching method can be compared directly. Table II shows the RD performance comparison of the alternate view from each sequence. From the table, it can be seen that the improvement is quite significant and the average bitrate reduction is around 1.89-4.84% and the average PSNR improvement is around 0.08-0.24 dB. Furthermore, in SCSH the mode selection distribution has more inter prediction modes instead of skip mode and intra modes. As in RDO, mode is selected based on the Lagrangian function. While the translation only prediction does not provide accurate prediction, the residue coding cost might be even higher than skip mode or intra modes. Table III shows the comparisons of mode distribution for QP of 22 and 37. It can be seen that in all cases the selection of 16×16, 16×8 and 8×16 mode have significant growth. With large QP, the reduction of skip mode is large. With small QP, the reduction of intra modes is large. As SCSH only apply on these inter modes, SCSH prevented a significant amount of intra and skip mode selection by providing better predictions.

TABLE II
RD comparison of inter-view prediction between JM17 and SCSH

| vassar | JM17 | | SCSH | | exit | JM17 | | SCSH | |
|---|---|---|---|---|---|---|---|---|---|
| QP | Bitrate | PSNR | Bitrate | PSNR | QP | Bitrate | PSNR | Bitrate | PSNR |
| 22 | 3200.57 | 41.63 | 3174.98 | 41.62 | 22 | 1851.47 | 42.32 | 1791.56 | 42.26 |
| 27 | 1439.78 | 38.11 | 1376.43 | 38.05 | 27 | 735.15 | 39.75 | 715.80 | 39.75 |
| 32 | 519.77 | 35.25 | 497.72 | 35.24 | 32 | 318.93 | 37.53 | 311.02 | 37.57 |
| 37 | 197.87 | 32.86 | 187.19 | 32.90 | 37 | 161.28 | 35.26 | 157.17 | 35.34 |
| Average bitrate reduction (%) | | | | −3.22 | Average bitrate reduction (%) | | | | −3.09 |
| Average PSNR improvement (dB) | | | | 0.10 | Average PSNR improvement (dB) | | | | 0.09 |
| ballroom | JM17 | | SCSH | | rena | JM17 | | SCSH | |
| QP | Bitrate | PSNR | Bitrate | PSNR | QP | Bitrate | PSNR | Bitrate | PSNR |
| 22 | 2930.93 | 41.90 | 2915.82 | 41.89 | 22 | 804.79 | 46.79 | 773.42 | 46.76 |
| 27 | 1463.84 | 38.83 | 1446.14 | 38.83 | 27 | 467.26 | 43.69 | 443.31 | 43.65 |
| 32 | 686.72 | 35.69 | 668.22 | 35.68 | 32 | 215.20 | 39.70 | 203.41 | 39.70 |
| 37 | 336.07 | 32.75 | 324.35 | 32.77 | 37 | 89.99 | 36.45 | 87.77 | 36.56 |

| | | | |
|---|---|---|---|
| Average bitrate reduction (%) | −1.89 | Average bitrate reduction (%) | −4.84 |
| Average PSNR improvement (dB) | 0.08 | Average PSNR improvement (dB) | 0.24 |

TABLE III
Mode distribution comparison between JM17 and SCSH

| | vassar | | | | exit | | | |
|---|---|---|---|---|---|---|---|---|
| | QP = 22 | | QP = 37 | | QP = 22 | | QP = 37 | |
| | JM17 | SCSH | JM17 | SCSH | JM17 | SCSH | JM17 | SCSH |
| Mode 0 (skip) | 294 | 269 | 44554 | 36507 | 1337 | 1139 | 53775 | 46599 |
| Mode 1 (16 × 16) | 12545 | 19639 | 25422 | 35808 | 12046 | 29604 | 19550 | 29941 |
| Mode 2 (16 × 8) | 4684 | 6189 | 5151 | 6168 | 4293 | 6665 | 2652 | 2617 |
| Mode 3 (8 × 16) | 7180 | 13769 | 6595 | 8724 | 6033 | 12280 | 2495 | 3688 |
| Mode 4 (8 × 8) | 4468 | 2275 | 1041 | 369 | 2406 | 1243 | 353 | 151 |
| Mode 5 intra 4 × 4 | 19770 | 16794 | 816 | 350 | 14850 | 13647 | 1637 | 1367 |
| Mode 6 intra 8 × 8 | 70079 | 60263 | 8075 | 5169 | 73691 | 51507 | 12977 | 11554 |
| Mode 7+ intra 16 × 16 | 980 | 802 | 28346 | 26905 | 5344 | 3915 | 26561 | 24083 |
| | ballroom | | | | rena | | | |
| | QP = 22 | | QP = 37 | | QP = 22 | | QP = 37 | |
| | JM17 | SCSH | JM17 | SCSH | JM17 | SCSH | JM17 | SCSH |
| Mode 0 (skip) | 15 | 11 | 18206 | 13930 | 3894 | 3183 | 48197 | 41008 |
| Mode 1 (16 × 16) | 23578 | 24526 | 33003 | 38194 | 39417 | 41665 | 13959 | 23319 |
| Mode 2 (16 × 8) | 9644 | 10063 | 6678 | 8721 | 5280 | 6021 | 1429 | 2574 |
| Mode 3 (8 × 16) | 10383 | 15479 | 5859 | 8635 | 12677 | 19967 | 1768 | 4151 |
| Mode 4 (8 × 8) | 5332 | 3634 | 1052 | 428 | 768 | 276 | 106 | 70 |
| Mode 5 intra 4 × 4 | 6152 | 5750 | 1610 | 979 | 5060 | 3678 | 474 | 404 |
| Mode 6 intra 8 × 8 | 64442 | 60184 | 22345 | 19107 | 44264 | 37308 | 12370 | 12703 |
| Mode 7+ intra 16 × 16 | 454 | 353 | 31247 | 30006 | 8640 | 7902 | 41697 | 35771 |

Overall Improvement of SCSH Inter-View Prediction

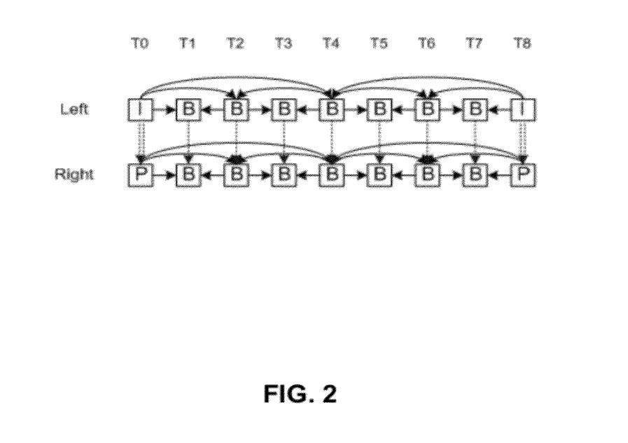

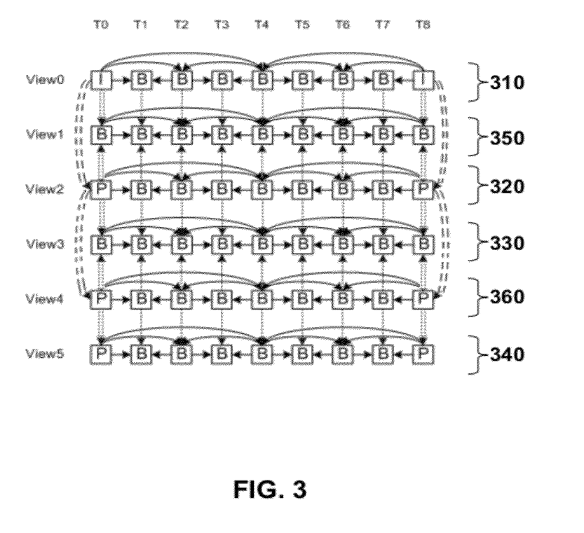

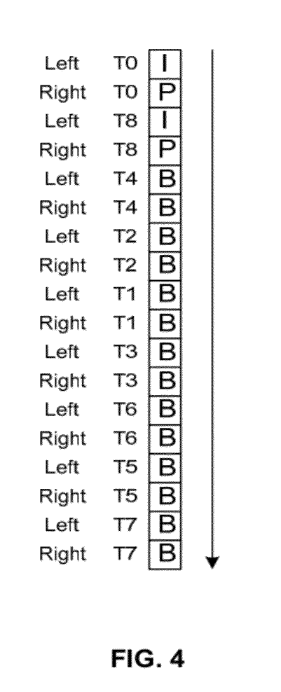

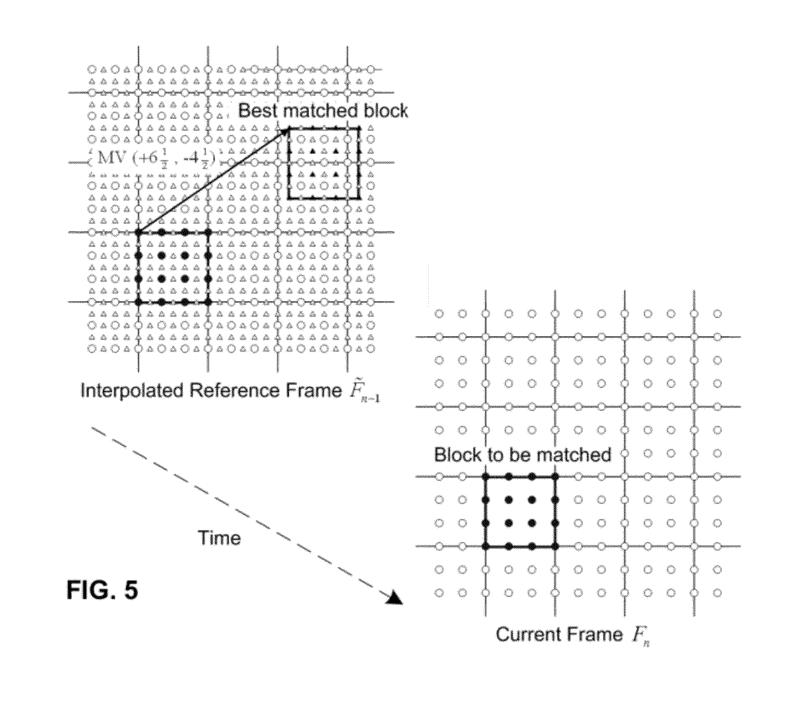

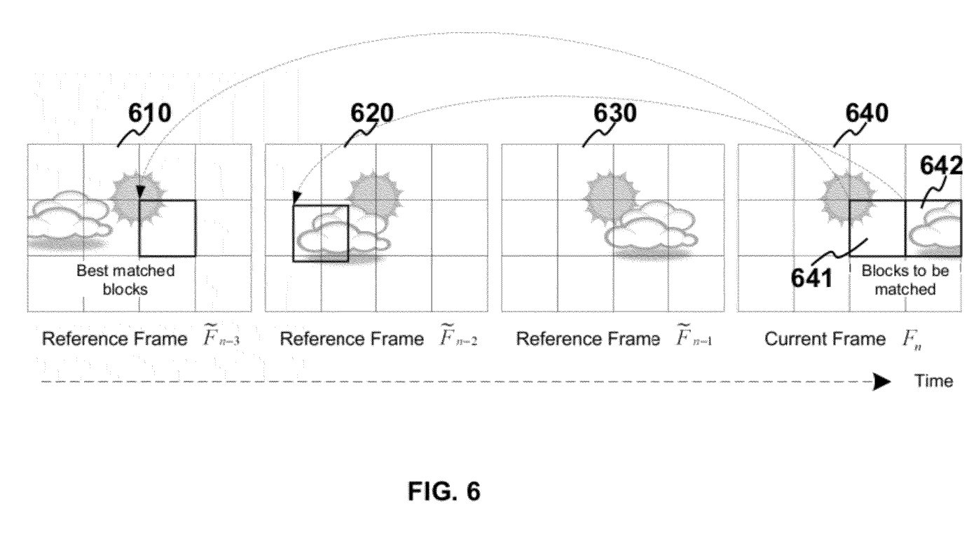

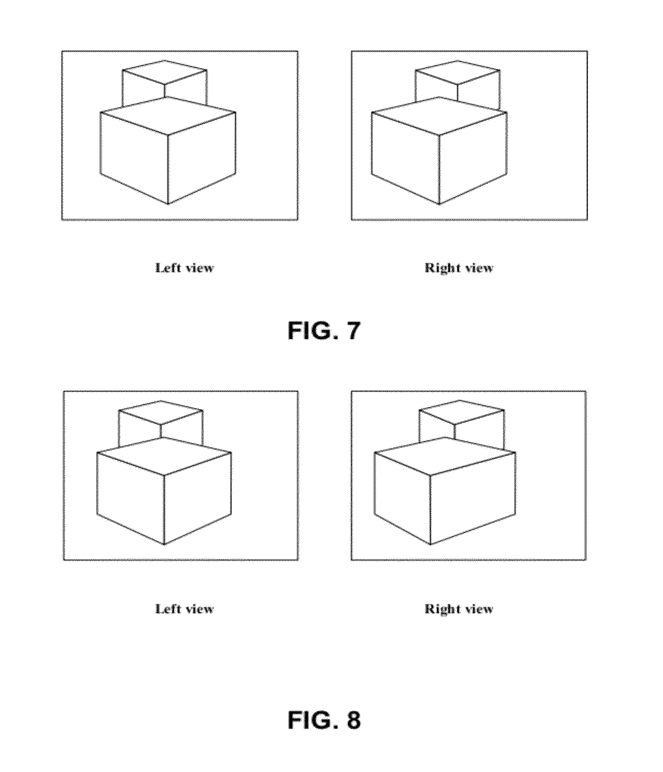

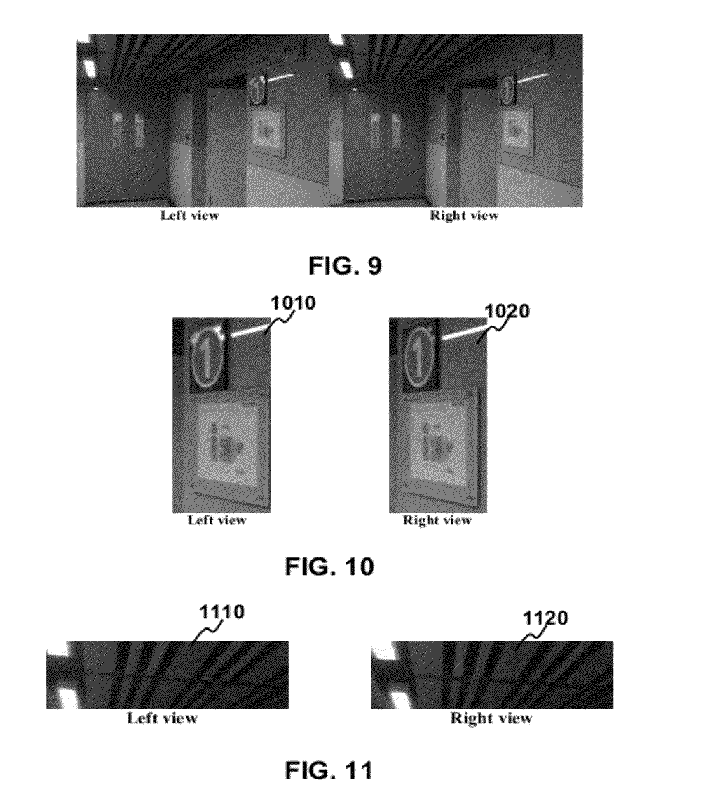

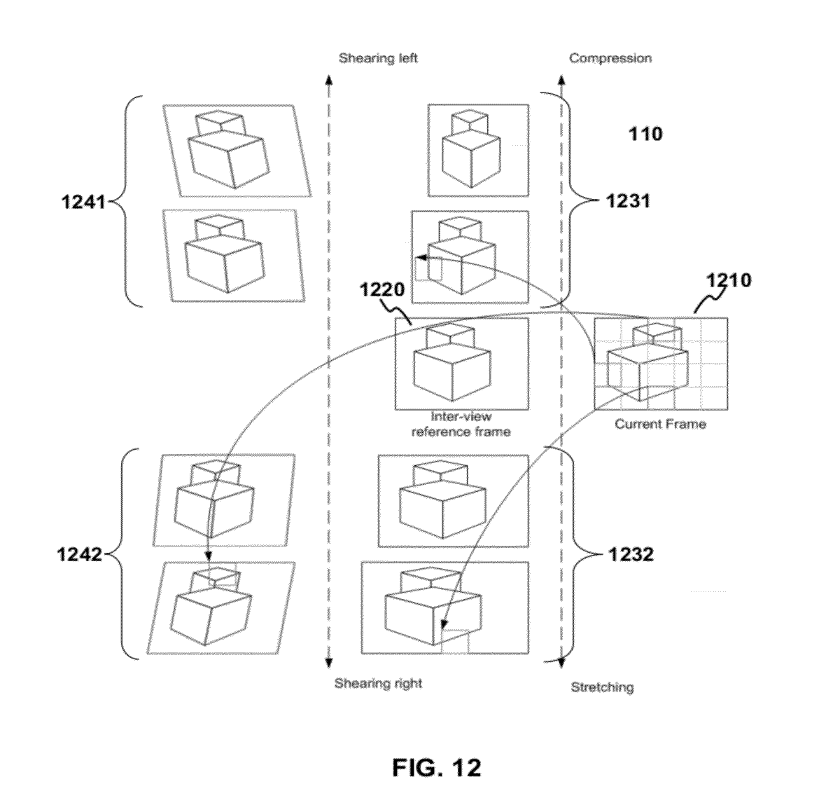

From above analysis, it can be seen that SCSH improves the inter-view prediction significantly. In practice, MVC uses prediction structures shown in FIGS. 2 and 3 that involved hierarchical B frames. However, inter-view prediction is normally not used as the inter prediction and bi-prediction already give very good predictions. As SCSH only applies on P frames, the improvement will be diluted by the B frames. In this part, the GOP structure is configured as shown in FIG. 2, that is 7 hierarchical B frames are added between I and P frames. Table IV shows that the RD performance of the alternate view that included all frames in that view. Although the improvement is diluted, there is still 0.72-2.25% of bitrate reduction and 0.03-0.13 dB of PSNR improvement.

TABLE IV
Comparison of overall RD performance between JM17 and SCSH

| vassar | JM17 | | SCSH | | exit | JM17 | | SCSH | |
|---|---|---|---|---|---|---|---|---|---|
| QP | Bitrate | PSNR | Bitrate | PSNR | QP | Bitrate | PSNR | Bitrate | PSNR |
| 22 | 1612.61 | 38.733 | 1608.27 | 38.733 | 22 | 1011.55 | 40.181 | 1010.21 | 40.181 |
| 27 | 479.85 | 36.437 | 473.49 | 36.434 | 27 | 367.99 | 38.505 | 364.31 | 38.508 |
| 32 | 188.84 | 34.736 | 182.25 | 34.72 | 32 | 173.97 | 36.526 | 171.58 | 36.53 |
| 37 | 84.86 | 32.803 | 80.28 | 32.797 | 37 | 97.41 | 34.269 | 96.16 | 34.301 |
| Average bitrate reduction (%) | | | | −2.04 | Average bitrate reduction (%) | | | | −1.31 |
| Average PSNR improvement (dB) | | | | 0.04 | Average PSNR improvement (dB) | | | | 0.03 |
| ballroom | JM17 | | SCSH | | rena | JM17 | | SCSH | |
| QP | Bitrate | PSNR | Bitrate | PSNR | QP | Bitrate | PSNR | Bitrate | PSNR |
| 22 | 2062.89 | 39.466 | 2066.36 | 39.463 | 22 | 581.60 | 45.039 | 573.14 | 45.051 |
| 27 | 963.82 | 37.144 | 961.63 | 37.147 | 27 | 308.35 | 41.466 | 302.39 | 41.463 |
| 32 | 477.88 | 34.336 | 472.5 | 34.326 | 32 | 158.49 | 37.547 | 153.86 | 37.531 |
| 37 | 252.09 | 31.416 | 246.5 | 31.406 | 37 | 81.58 | 34.281 | 80.51 | 34.356 |

| | | | |
|---|---|---|---|
| Average bitrate reduction (%) | −0.72 | Average bitrate reduction (%) | −2.25 |
| Average PSNR improvement (dB) | 0.03 | Average PSNR improvement (dB) | 0.13 |

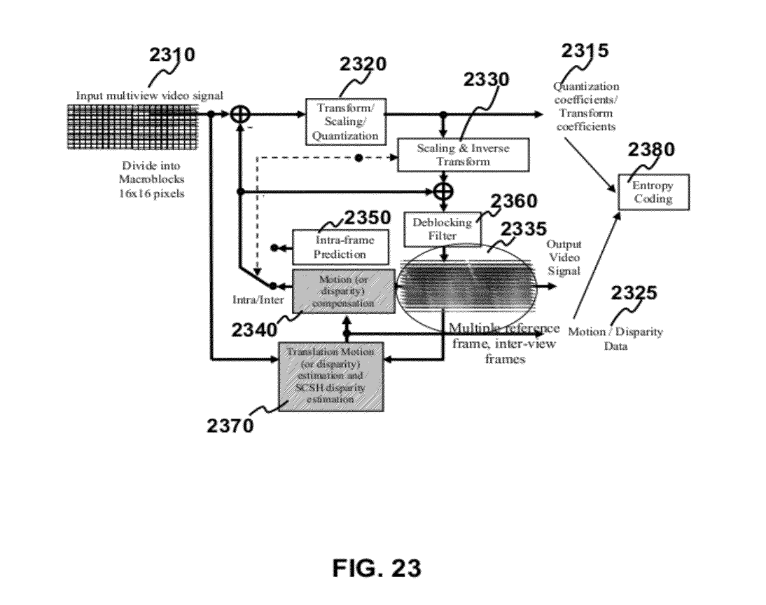

FIG. 23 shows a block diagram illustrating an exemplary embodiment of how the present invention is used in an exemplary encoder system. An input multiview video signal 2310 is processed by motion estimation module 2370 which takes into account of disparity and translation motions. The motion estimation module 2370 performs translation motion estimation which includes disparity and SCSH disparity estimation. The motion estimation module 2370 uses interpolated frames from sub-pixel motion estimation to generate reference frames. The motion estimation module 2370 uses multiple reference frames and inter-view frames from a buffer 2135. Interpolation is applied to frames stored in the buffer 2335 to generate interpolated frames. These multiple reference frames in the buffer 2335 are also served as output video signal as they represents frames from different time instances in a video. Before being stored in the buffer 2335, these multiple reference frames and inter-view frames are processed by modules 2320 for processes such as transform, scaling and quantization in order to obtain parameters 2315 such as quantization coefficients and transform coefficients, and needs to be subsequently processed by modules 2330 for processes such as scaling, inverse transform or dequantization as well as deblocking by a deblocking filter 2360.

The motion and disparity data 2325 obtained from the motion estimation module 2370 and the parameters 2315 such as quantization coefficients are processed by an entropy coding module 2380. An intra-frame prediction module 2350 and a motion and disparity compensation module 2340 are used to perform intra-frame prediction and inter-frame prediction respectively. The motion and disparity compensation module 2340 receives motion and disparity data 2325 from the motion estimation module 2370 and the multiple temporal reference frames from the buffer 2335. After the intra-frame prediction and the inter-frame prediction provide outputs for processes such as scaling, quantization and dequantization, transform and inverse transform, in modules 2320 and 2330.

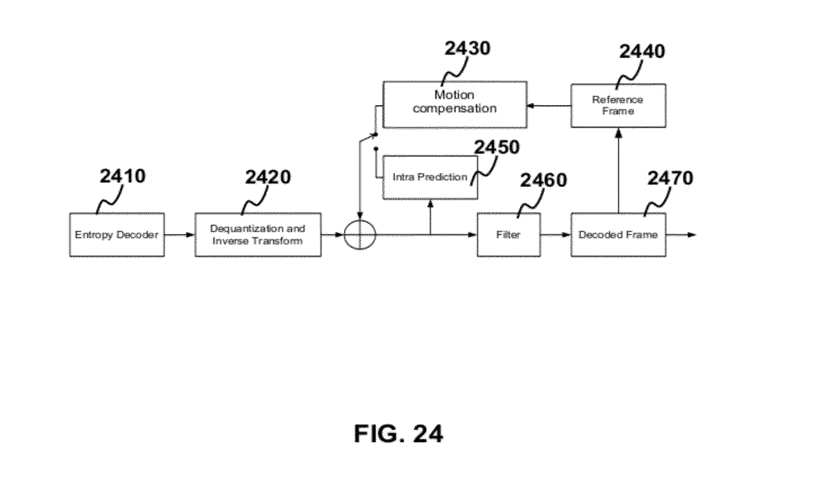

FIG. 24 shows a block diagram illustrating an exemplary embodiment of how the present invention is used in an exemplary decoder system. At a decoder side, the input signal as received by the decoder is decoded by an entropy decoder 2410. The entropy decoder 2410 determines whether to switch SCSH effect on or off by identifying the mode number from the decoded signal. After processing by the entropy decoder 2410, the decoded signal is processed by dequantization and inverse transform 2420. To obtain the decoded frame 2470, motion compensation 2430 is performed using the decoded frame 2470 as the reference frame 2440. The SCSH parameters are associated with the reference frame number, so the SCSH parameters are extracted from the reference frame number. The sampling pattern list for the SCSH parameter which is the same as the one in the encoder is hardcoded in the decoder. The resulting signal from the dequantization and inverse transform 2420 is processed with the output from either motion compensation 2430 or intra prediction 2450 to generate a processed signal. The motion compensation 2430 includes the translational motion, the zoom motion, and the disparity. The processed signal is further processed by a filter 2460 and is used for intra prediction 2450. After filtering by the filter 2460, a decoded frame 2470 is generated.

Embodiments of the present invention may be implemented in the form of software, hardware, application logic or a combination of software, hardware and application logic. The software, application logic and/or hardware may reside on integrated circuit chips, modules or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory computer-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit).

Apparatus or devices which are described in this specification can be implemented by a programmable processor, a computer, a system on a chip, or combinations of them, by operating on input date and generating output. Apparatus or devices can include special purpose logic circuitry, e.g., an FPGA (field programmable gate array) or an ASIC (application-specific integrated circuit). Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

As used herein, the term “processor” broadly relates to logic circuitry that responds to and processes instructions. Processors suitable for the present invention include, for example, both general and special purpose processors such as microprocessors, and any one or more processors of any kind of digital computer. Generally, a processor will receive instructions and data from one or more memory devices such as a read-only memory, a random access memory, a non-transitory computer-readable media, or combinations thereof. Alternatively, the processor may include special purpose logic circuitry, e.g., an FPGA (field programmable gate array) or an ASIC (application-specific integrated circuit configured to perform the functions described above. When the processor is a computer, the elements generally include one or more microprocessors for performing or executing instructions, and one or more memory devices for storing instructions and data.

Computer-readable medium that can store data and instructions for the processes of the present invention as described in this specification may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. Computer-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Embodiments and/or features as described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with one embodiment as described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The whole specification contains many specific implementation details. These specific implementation details are not meant to be construed as limitations on the scope of the invention or of what may be claimed, but rather as descriptions of features specific to particular embodiments of the invention.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims.

Certain functions which are described in this specification may be performed in a different order and/or concurrently with each other. Furthermore, if desired, one or more of the above-described functions may be optional or may be combined.

The above descriptions provide exemplary embodiments of the present invention, but should not be viewed in a limiting sense. Rather, it is possible to make variations and modifications without departing from the scope of the present invention as defined in the appended claims.

The present invention may be implemented using general purpose or specialized computers or microprocessors programmed according to the teachings of the present disclosure. Computer instructions or software codes running in the general purpose or specialized computers or microprocessors can readily be prepared by practitioners skilled in the software art based on the teachings of the present disclosure.

In some embodiments, the present invention includes a computer storage medium having computer instructions or software codes stored therein which can be used to program a computer or microprocessor to perform any of the processes of the present invention. The storage medium can include, but is not limited to, floppy disks, optical discs, Blu-ray Disc, DVD, CD-ROMs, and magneto-optical disks, ROMs, RAMs, flash memory devices, or any type of media or device suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A multiview video coding device, comprising:
one or more processors configured to;
receive a video signal representing a plurality of multiview video frames, the number of multiview video frames ranging from 1 to N, where N is a whole number greater than or equal to 2;
select one multiview video frame from the N multiview video frames as a reference video frame;
interpolate the reference video frame by a scale of M into an interpolated reference video frame such that the number of pixels of the reference video frame is increased by M times with each of the pixels of the reference video frame generating M by M subpixels; and
generate a subsampled reference block by sampling the interpolated reference video frame such that a deformation is introduced to the subsampled reference block.

2. The multiview video coding device according to claim 1, wherein said one or more processors further configured to:
divide each of the multiview video frames into a plurality of blocks, each block having a size of A by B such that said one or more processors process data in form of block by block instead of frame by frame, where A and B are whole numbers respectively.

3. The multiview video coding device according to claim 1, wherein:
said deformation has a horizontal effect by adjusting a horizontal sampling rate when sampling the interpolated reference video frame.

4. The multiview video coding device according to claim 1, wherein:
said deformation has a shearing effect by applying a shear factor when sampling the interpolated reference video frame.

5. The multiview video coding device according to claim 1, wherein said one or more processors further configured to:
provide one or more additional reference frames such that each of the additional reference frames are interpolated and sampled without deformation.

6. The multiview video coding device according to claim 1, wherein said one or more processors further configured to:
generate a pixel location for chroma component corresponding to the deformation.

7. The multiview video coding device according to claim 1, wherein:
one or more zooming effects are applied to said subsampled reference block by using various sampling rates.

8. The multiview video coding device according to claim 1, wherein said one or more processors further configured to:
perform disparity vector search among one or more reference frames interpolated and sampled with deformation and a plurality of additional reference frames interpolated and sampled without deformation.

9. The multiview video coding device according to claim 3, wherein:
said horizontal effect is a compression when said horizontal sampling rate is selected to be higher than a vertical sampling rate for sampling the interpolated reference video frame.

10. The multiview video coding device according to claim 3, wherein:
said horizontal effect is a stretching when said horizontal sampling rate is selected to be lower than a vertical sampling rate for sampling the interpolated reference video frame.

11. A multiview video coding method comprising:
receiving a video signal representing a plurality of multiview video frames, the number of multiview video frames ranging from 1 to N, where N is a whole number greater than or equal to 2;
selecting one multiview video frame from the N multiview video frames as a reference video frame;
interpolating the reference video frame by a scale of M into an interpolated reference video frame such that the number of pixels of the reference video frame is increased by M times with each of the pixels of the reference video frame generating M by M subpixels; and
generating a subsampled reference block by sampling the interpolated reference video frame such that a deformation is introduced to the subsampled reference block.

12. The multiview video coding method according to claim 1, further comprising:
dividing each of the multiview video frames into a plurality of blocks, each block having a size of A by B such that said one or more processors process data in form of block by block instead of frame by frame, where A and B are whole numbers respectively.

13. The multiview video coding method according to claim 1, wherein:
said deformation has a horizontal effect by adjusting a horizontal sampling rate when sampling the interpolated reference video frame.

14. The multiview video coding method according to claim 1, wherein:
said deformation has a shearing effect by applying a shear factor when sampling the interpolated reference video frame.

15. The multiview video coding method according to claim 1, further comprising:
providing one or more additional reference frames such that each of the additional reference frames are interpolated and sampled without deformation.

16. The multiview video coding method according to claim 1, further comprising:
generating a pixel location for chroma component corresponding to the deformation.

17. The multiview video coding method according to claim 1, wherein:
one or more zooming effects are applied to said subsampled reference block by using various sampling rates.

18. The multiview video coding method according to claim 1, further comprising:
performing disparity vector search among one or more reference frames interpolated and sampled with deformation and a plurality of additional reference frames interpolated and sampled without deformation.

19. The multiview video coding method according to claim 13, wherein:
said horizontal effect is a compression when said horizontal sampling rate is selected to be higher than a vertical sampling rate for sampling the interpolated reference video frame.

20. The multiview video coding method according to claim 13, wherein:
said horizontal effect is a stretching when said horizontal sampling rate is selected to be lower than a vertical sampling rate for sampling the interpolated reference video frame.
